(19) United States
(12) Patent Application Publication
(10) Pub. No.: US 2022/0414383 A1
(43) Pub. Date: Dec. 29, 2022

(54) METHODS, APPARATUSES, DEVICES AND STORAGE MEDIA FOR SWITCHING STATES OF TABLETOP GAMES

(71) Applicant: SENSETIME INTERNATIONAL PTE. LTD., Singapore (SG)

(72) Inventors: Bing SUN, Singapore (SG); Xinxin Wang, Singapore (SG)

(21) Appl. No.: 17/363,451

(22) Filed: Jun. 30, 2021

Related U.S. Application Data
(63) Continuation of application No. PCT/IB2021/055748, filed on Jun. 28, 2021.

(30) Foreign Application Priority Data
Jun. 24, 2021 (SG) 10202106955X

(51) Int. Cl. G06K 9/00; G06T 7/70; G07F 17/32

(52) U.S. Cl. CPC G06K 9/00771; G06T 7/70; G07F 17/3241; G06K 2209/21; G06T 2207/30232

(57) ABSTRACT

The present disclosure provides a method, an apparatus, a device and a storage medium for switching states of a tabletop game. The method can include: obtaining a tabletop image of a tabletop game which is in a game coin settlement state; obtaining position information of each of one or more target objects involved in the tabletop image by performing object detection on the tabletop image, wherein the one or more target objects comprise at least one of one or more card objects and one or more game coin objects; determining, according to the position information of each of the one or more target objects, whether a game area of a game table involves a target object and whether a game coin storage box on the game table is in a closed state; and switching the game to a game starting state in response to determining that the game area involves none target object and the game coin storage box is in the closed state.

### CROSS-REFERENCE TO RELATED APPLICATION

The present application is a continuation of International Application No. PCT/IB2021/055748 filed on Jun. 28, 2021, which claims priority to Singapore Patent Application No. 10202106955X, filed on Jun. 24, 2021, all of which are incorporated herein by reference in their entirety.

### TECHNICAL FIELD

The present disclosure relates to computer technology, and in particular to a method, an apparatus, a device and a storage medium for switching states of a tabletop game.

### BACKGROUND

In a card game, a game process is generally under monitoring, and different game stages correspond to different game rules. Therefore, it is necessary to maintain a game state corresponding to a current game stage, so that a corresponding rule can be determined according to the current game state for monitoring the card game.

A state of a tabletop game can at least include a game coin settlement state and a game starting state. If a round of game is in the game coin settlement state, the game can be switched to the game starting state to proceed to the next round of game.

At present, switching a game state has to rely on a game manager (such as a game dealer) to trigger a button. When the game is in the game coin settlement state and the next round of card game is about to be played, the game manager can trigger a button deployed near a tabletop. Upon a background system detects the trigger operation of the game manager, the background system can switch the maintained game state to the game starting state.

It is readily apparent that in the process of game state switching, the game manager needs to be relied on. Therefore, on the one hand, it is necessary to increase the actions of the game manager, which is not friendly to the game manager, and since a player can perceive the game manager triggering action, the game experience is not good; on the other hand, the game state switching can be abnormal due to the game manager accidentally touching the button or forgetting to trigger the button.

### SUMMARY

In view of above, the present disclosure provides a method of switching states of a tabletop game, including: obtaining a tabletop image of a tabletop game which is in a game coin settlement state; obtaining position information of each of one or more target objects involved in the tabletop image by performing object detection on the tabletop image, wherein the one or more target objects include at least one of one or more card objects and one or more game coin objects; determining, according to the position information of each of the one or more target objects, whether a game area of a game table involves a target object; determining whether a game coin storage box on the game table is in a closed state; and switching the game to a game starting state in response to determining that the game area involves none target object and the game coin storage box is in the closed state.

In some implementations, determining, according to the position information of each of the one or more objects, whether the game area of the game table involves a target object, includes: obtaining a tabletop hot zone map corresponding to the tabletop image, wherein the tabletop hot zone map includes a game hot zone which corresponds to an image block in the tabletop image associated with the game area; determining, according to the position information of each of the one or more target objects, at least one of one or more first hot zones and one or more second hot zones in the tabletop hot zone map, wherein each of the one or more card objects is involved in one of the one or more first hot zones in the tabletop hot zone map and each of the one or more game coin objects is involved in one of the one or more second hot zones in the tabletop hot zone map; determining, in response to that the one or more first hot zones cover the game hot zone, that the game area involves a card object; determining, in response to that the one or more first hot zones do not cover the game hot zone, that the game area involves none card object; determining, in response to that the one or more second hot zones cover the game hot zone, that the game area involves a game coin object; and determining, in response to that the one or more second hot zones do not cover the game hot zone, that the game area involves none game coin object.

In some implementations, the method further includes: storing the obtained position information of each of the one or more target objects in a first message queue; storing, in a second message queue in a case where the one or more target objects include the one or more card objects, a first identifier of each of the one or more first hot zones in association with the card object involved in the first hot zone; and storing, in the second message queue in a case where the one or more target objects include the one or more game coin objects, a second identifier of each of the one or more second hot zones in association with the game coin object involved in the second hot zone.

In some implementations, the method further includes: obtaining, from the second message queue, each of the card objects together with corresponding first identifier and each of the game coin objects together with corresponding second identifier; determining, in response to that one of the obtained first identifiers matches an identifier of the game hot zone, that the one or more first hot zones cover the game hot zone; and determining, in response to that one of the obtained second identifiers matches the identifier of the game hot zone, that the one or more second hot zones cover the game hot zone.

In some implementations, determining, according to the position information of each of the one or more target objects, at least one of the one or more first hot zones and the one or more second hot zones in the tabletop hot zone map, includes: determining, according to positional coordinates of a pixel within a bounding box of the target object in the tabletop image, a target pixel having the positional coordinates in the tabletop hot zone map; determining, in response to the target object being a card object, a hot zone including the target pixel as the first hot zone; and determining, in response to the target object being a game coin object, a hot zone including the target pixel as the second hot zone.

In some implementations, the tabletop hot zone map further includes a first game coin storage box hot zone which corresponds to an image block in the tabletop image associated with the game coin storage box; determining whether the game coin storage box on the game table is in the closed state includes: in response to that the one or more second hot zones cover the first game coin storage box hot zone, determining that the game coin storage box is in an opened state; in response to that the one or more second hot zones do not cover the first game coin storage box hot zone, determining that the game coin storage box is in the closed state.

In some implementations, the game coin storage box includes a preset game coin storage layer; the tabletop hot zone map further includes a second game coin storage box hot zone which corresponds to an image block in the tabletop image associated with the preset game coin storage layer when the game coin storage box is opened; determining whether the game coin storage box on the game table is in the closed state includes: in response to that the one or more second hot zones cover the second game coin storage box hot zone, determining that the game coin storage box is in an opened state; and in response to that the one or more second hot zones do not cover the second game coin storage box hot zone, determining that the game coin storage box is in the closed state.

In some implementations, the method further includes: obtaining a game state identifier that represents a current game stage of the game; and in response to that the game state identifier matches an identifier of the game coin settlement state, determining that the game currently is in the game coin settlement state.

In some implementations, the game area includes a card placement area and a game coin placement area; and the game starting state includes a game coin placement state.

The present disclosure also provides an apparatus for switching states of a tabletop game, including: an obtaining module configured to obtain a tabletop image of a tabletop game which is in a game coin settlement state; an object detecting module configured to obtain position information of each of one or more target objects involved in the tabletop image by performing object detection on the tabletop image, wherein the one or more target objects include at least one of one or more card objects and one or more game coin objects; a determining module configured to determine, according to the position information of each of the one or more target objects, whether a game area of a game table involves a target object, and whether a game coin storage box on the game table is in a closed state; and a switching module configured to switch the game to a game starting state, in response to determining that the game area involves none target object and the game coin storage box is in the closed state.

In some implementations, the determining module is configured to: obtain a tabletop hot zone map corresponding to the tabletop image; wherein the tabletop hot zone map includes a game hot zone which corresponds to an image block in the tabletop image associated with the game area; determine, according to the position information of each of the one or more target objects, at least one of one or more first hot zones and one or more second hot zones in the tabletop hot zone map, wherein each of the one or more card objects is involved in one of the one or more first hot zones in the tabletop hot zone map and each of the one or more game coin objects is involved in one of the one or more second hot zones in the tabletop hot zone map; in response to that the one or more first hot zones cover the game hot zone, determine that the game area involves a card object; in response to that the one or more first hot zones do not cover the game hot zone, determine that the game area involves none card object; in response to that the one or more second hot zones cover the game hot zone, determine that the game area involves a game coin object; and in response to that the one or more second hot zones do not cover the game hot zone, determine that the game area involves none game coin object.

In some implementations, the apparatus further includes: a storage module configured to store the obtained position information of each of the one or more target objects in a first message queue; store, in a second message queue in a case where the one or more target objects include the one or more card objects, a first identifier of each of the one or more first hot zones in association with the card object involved in the first hot zone; and store, in the second message queue in a case where the one or more target objects include the one or more game coin objects, a second identifier of each of the one or more second hot zones in association with the game coin object involved in the second hot zone.

In some implementations, the apparatus further includes: a hot zone determining module configured to obtain, from the second message queue, each of the card objects together with corresponding first identifier and each of the game coin objects together with corresponding second identifier; in response to that one of the obtained first identifiers matches an identifier of the game hot zone, determine that the one or more first hot zones cover the game hot zone; and in response to that one of the obtained second identifiers matches the identifier of the game hot zone, determine that the one or more second hot zones cover the game hot zone.

In some implementations, the determining module is configured to: determine, according to positional coordinates of a pixel within a bounding box of the target object in the tabletop image, a target pixel having the positional coordinates in the tabletop hot zone map; determine, in response to the target object being a card object, a hot zone including the target pixel as the first hot zone; and determine, in response to the target object being a game coin object, a hot zone including the target pixel as the second hot zone.

In some implementations, the tabletop hot zone map further includes a first game coin storage box hot zone which corresponds to an image block in the tabletop image associated with the game coin storage box; the determining module is configured to: in response to that the one or more second hot zones cover the first game coin storage box hot zone, determine that the game coin storage box is in an opened state; and in response to that the one or more second hot zones do not cover the first game coin storage box hot zone, determine that the game coin storage box is in the closed state.

In some implementations, the game coin storage box includes a preset game coin storage layer; the tabletop hot zone map further includes a second game coin storage box hot zone which corresponds to an image block in the tabletop image associated with the preset game coin storage layer when the game coin storage box is opened; the determining module is configured to: in response to that the one or more second hot zones cover the second game coin storage box hot zone, determine that the game coin storage box is in an opened state; and in response to that the one or more second hot zones do not cover the second game coin storage box hot zone, determine that the game coin storage box is in the closed state.

In some implementations, the apparatus further includes: a game state determining module configured to obtain a game state identifier that represents a current game stage of the game; and in response to that the game state identifier matches an identifier of the game coin settlement state, determine that the game currently is in the game coin settlement state.

In some implementations, the game area includes a card placement area and a game coin placement area; and the game starting state includes a game coin placement state.

The present disclosure also provides an electronic device including: a processor; and a memory for storing processor executable instructions; wherein the processor, by running the executable instructions, implements the method of switching states of a tabletop game described in any of the above-mentioned implementations.

The present disclosure also provides a computer-readable storage medium, wherein the storage medium stores a computer program, and the computer program is used to cause a processor to perform the method of switching states of a tabletop game described in any of the above-mentioned implementations.

In the solution described above, position information of a game coin object and a card object involved in a tabletop image can be analyzed to confirm whether the game coin object(s) and the card object(s) in the game area are cleared, and whether a game coin storage box is closed. When the game coin object(s) and the card object(s) are cleared, the game coin storage box is in a closed state and the current stage indicates a game coin settlement state, the game is switched to a game starting state.

Therefore, the game state can be automatically switched according to the tabletop image corresponding to the tabletop game, so that on the one hand, there is no need for a game manager to perform any action when switching states, which is more friendly to the game manager, and the game state switching is not perceptible for players, which can enhance the player's game experience; on the other hand, it can avoid abnormal game state switching caused by the game manager accidentally touching the button or forgetting to trigger the button.

It is to be understood that the above general descriptions and the below detailed descriptions are merely exemplary and explanatory, and are not intended to limit the present disclosure.

### BRIEF DESCRIPTION OF THE DRAWINGS

In order to more clearly illustrate the specific embodiments of the present disclosure or the technical solutions in the prior art, accompanying drawings to be referred in the specific embodiments or the description of the prior art will be briefly introduced below. Apparently, the accompanying drawings in the following description show some embodiments of the present disclosure. For those of ordinary skill in the art, other drawings can be obtained based on these drawings without creative endeavor.

FIG. 1 is a method flowchart illustrating a method of switching states of a tabletop game according to the present disclosure;

FIG. 2 is a schematic diagram illustrating an object detection process according to the present disclosure;

FIG. 3 is a schematic diagram illustrating a process of determining a game coin placement area and a card placement area according to the present disclosure;

FIG. 4 is a schematic diagram illustrating a game scene according to the present disclosure;

FIG. 5 is a schematic block diagram illustrating an apparatus for switching states of a tabletop game according to the present disclosure; and

FIG. 6 is a schematic diagram illustrating a hardware structure of an electronic device according to the present disclosure.

### DETAILED DESCRIPTION OF THE EMBODIMENTS

Examples will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

The terms used in the present disclosure are for the purpose of describing particular examples only, and are not intended to limit the present disclosure. Terms determined by “a”, “the” and “said” in their singular forms in the present disclosure and the appended claims are also intended to include plurality, unless clearly indicated otherwise in the context. It should also be understood that the term “and/or” as used herein is and includes any and all possible combinations of one or more of the associated listed items. It is to be understood that, depending on the context, the word “in response to” as used herein may be interpreted as “when” or “upon” or “in response to determining”.

Based on this, the present disclosure provides a method of switching states of a tabletop game. In this method, position information of a game coin object and a card object involved in a tabletop image can be analyzed to confirm whether the game coin object(s) and the card object(s) in the game area are cleared, and whether a game coin storage box is closed. When the game coin object(s) and the card object(s) are cleared, the game coin storage box is in a closed state and the current stage indicates a game coin settlement state, the game is switched to a game starting state.

Therefore, the game state can be automatically switched according to the tabletop image corresponding to the tabletop game, so that on the one hand, there is no need for a game manager to perform any action when switching states, which is more friendly to the game manager, and the game state switching is not perceptible for players, which can enhance the players' game experience; on the other hand, it can avoid abnormal game state switching caused by the game manager accidentally touching the button or forgetting to trigger the button.

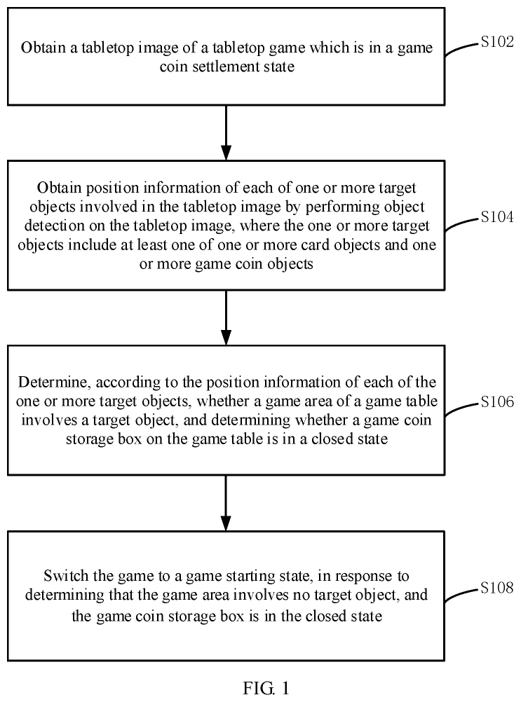

Referring to FIG. 1, FIG. 1 is a method flowchart illustrating a method of switching states of a tabletop game according to the present disclosure.

The method (hereinafter referred to as the switching method) of switching game states shown in FIG. 1 can be applied to an electronic device. The electronic device can perform the switching method by installing software logic corresponding to the switching method. The type of the electronic device can be a notebook computer, a computer, a server, a mobile phone, a PAD terminal, and so on. The type of the electronic device is not particularly limited in the present disclosure. The electronic device can also be a client device or a server device, which is not particularly limited herein.

In some embodiments, the electronic device can be a node device deployed at a card game site. The node device can be connected to several image acquisition devices deployed on the game site to obtain the captured live images. The node device can analyze the live images to determine a state of a tabletop game. In some implementations, the node device can maintain the game state, or send the determined game state to a cloud server or a background server for maintenance.

In some implementations, the node device can be used as an edge computing device, corresponding to a game table in a one-to-one correspondence. Each node device can obtain the captured image from the image acquisition device deployed above the corresponding game table, and monitor the game played on the game table based on the captured image. The node device can transmit a monitoring result to a cloud server or a background server. Therefore, on the one hand, the monitoring of the game will not be affected when a central node fails; on the other hand, even if the network bandwidth is limited, the multi-channel image acquisition device can properly transmit data to the central node or the cloud server.

The following takes the executive subject being a node device as an example for description. The node device maintains the game states of the tabletop game.

The tabletop game in the present disclosure can refer to any type of tabletop game. For example, the table game can be a card game, a chess game and the like.

In a tabletop game, at least a game starting state and a game coin settlement state can be included.

The game starting state refers to a state at the beginning of a game (before the cards are dealt). The game starting state can include a plurality of types of states in different scenes. For example, in a poker game, before the cards are dealt, a player needs to place a game coin to choose a game party. At this time, the game starting state can include a game coin placement state.

The game coin settlement state refers to a state when a game is over and a result is to be settled. For example, in a poker game, after cards are dealt and a player checks the cards, a game result needs to be settled.

As shown in FIG. 1, the switching method can include the following steps S102-S108.

At S102, obtaining a tabletop image of a tabletop game which is in a game coin settlement state.

At S104, obtaining position information of each of one or more target objects involved in the tabletop image by performing object detection on the tabletop image, where the one or more target objects include at least one of one or more card objects and one or more game coin objects.

At S106, determining, according to the position information of each of the one or more target objects, whether a game area of a game table involves a target object, and determining whether a game coin storage box on the game table is in a closed state.

At S108, switching the game to a game starting state, in response to determining that the game area involves none target object and the game coin storage box is in the closed state.

The tabletop image can refer to an image captured for a game tabletop by an image acquisition device deployed at a preset position of the game tabletop. In some implementations, the preset position refers to positions such as directly above the game tabletop, at the upper left and upper right of the game tabletop. As a result, images of the complete tabletop can be captured, and then information on objects placed on the game tabletop can be completely acquired, and the analysis effect can be improved.

In some implementations, in order to switch the game states of the table game, the node device can perform S102.

In some implementations, the node device can obtain the tabletop image captured for the game tabletop in real time.

Then the node device can perform S104.

The card object can refer to an object distributed to a game participant in a card game. The card object can generally include a face value, and a game result can be determined by determining the face values of the card objects held by each of the participants.

The game coin object can refer to an object representing a certain amount held by a game participant. The present disclosure does not specifically limit the shape, color, and other properties of the game coin object.

In some example implementations, the node device can be equipped with an object detection model built based on a neural network. The object detection model can be a model built based on a RCNN (Region Convolutional Neural Network), a FAST-RCNN (Fast Region Convolutional Neural Network) or a FASTER-RCNN (Faster Region Convolutional Neural Network). The present disclosure does not specifically limit the network structure of the object detection model.

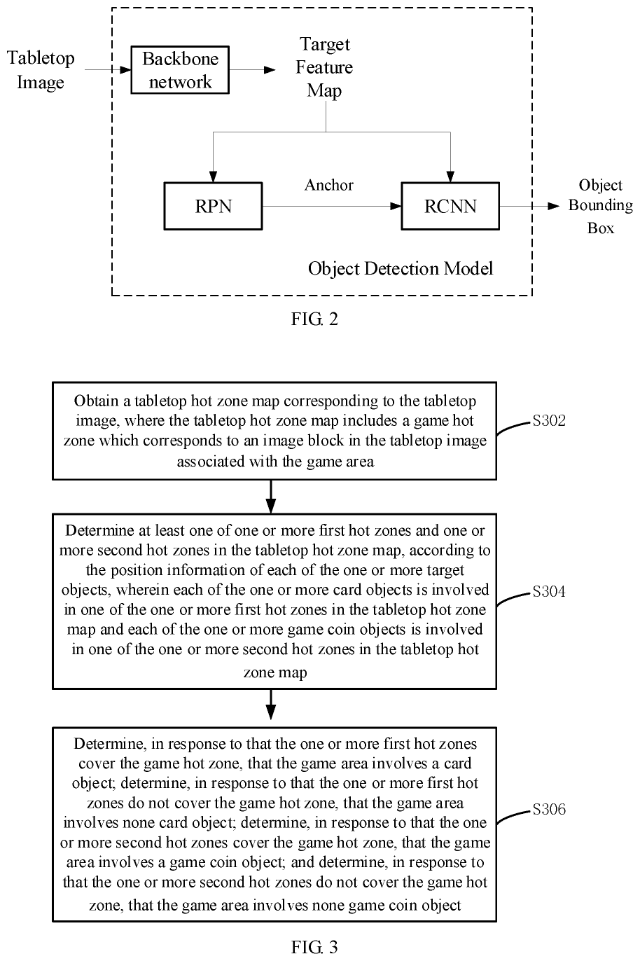

Referring to FIG. 2, FIG. 2 is a schematic diagram illustrating an object detection process according to the present disclosure. It should be noted that FIG. 2 only schematically illustrates the object detection process, and does not specifically limit the present application.

The object detection model shown in FIG. 2 can be a model built based on the FASTER-RCNN network. The model can include at least a backbone network (backbone), a RPN (Region Proposal Network), and a RCNN (Region-based Convolutional Neural Network).

Here, the backbone network can perform several convolution operations on a tabletop image to obtain a target feature map. The RPN network is used to process the target feature map to obtain anchors corresponding to one or more game coin objects and one or more card objects in the tabletop image. The RCNN network is used to perform bbox (bounding box) regression and classification according to the anchors output by the RPN network and the target feature map output by the backbone network, to obtain respective bounding box corresponding to the game coin objects and the card objects in the tabletop image. In some examples, the output result of the object detection model can include respective position information and size information of the bounding boxes corresponding to the game coin objects and the card objects.

In some examples, supervised training can be performed on the object detection model with training samples. In some examples, a plurality of tabletop images can be obtained first, and real information of bounding boxes corresponding to card objects and game coin objects in each of the plurality of tabletop images can be labeled to obtain a plurality of training samples. Then, the object detection model can be trained with the training samples labeled with the real information until the model converges. In some implementations, the real information can include coordinates of a center point of an area enclosed by a bounding box.

After the training is completed, the object detection model can be used to perform object detection on the obtained tabletop image to obtain respective position information and size information of the bounding boxes corresponding to the card objects and the game coin objects involved in the image. Then, the obtained position information of the bounding boxes corresponding to the objects can be determined as the position information of the objects. In some implementations, coordinates of a center point of an area enclosed by a bounding box corresponding to an object can be determined as position of the object. In some implementations, the obtained position information of each of the one or more card objects and each of the one or more game coin objects can be stored in a first message queue.

After a card object and a game coin object are detected, the node device can perform S106. Here, S106 can include: S1062, according to the position information of each of the one or more target objects, determining whether the game area of the game table involves a card and a game coin; and S1064, determining whether the game coin storage box on the game table is in the closed state.

In some implementations, the game tabletop appearing in the tabletop image can be divided into a plurality of areas. Here, the plurality of areas include at least a game area and a game coin storage box area corresponding to a position for placing a game coin storage box. The game area indicates a valid operating area during the game, including an area where players perform operations on game coins, and where game controllers perform operations on game items such as cards and game coins. In some implementations, the game area can include a game coin placement area for placing game coins and a card placement area for placing cards.

In some implementations, the plurality of areas of the game tabletop can be square areas, and coordinates of four vertices corresponding to each area can be maintained in the node device. In this example, it can be determined whether each target object is involved in the game area according to the position information of each target object, and based on this, it can be determined whether the game area involves a game coin object and a card object.

When S1062 is performed, each of the game coin objects and the card objects can be used as a target object, and perform:

obtaining position information corresponding to the target object from the first message queue. In this example, the position information includes coordinates (x₀, y₀) corresponding to the center point of the area enclosed by the bounding box corresponding to the target object, or the coordinates of the vertices of the bounding box.

Then, it can be determined whether the position of the target object indicated by the position information is in the game area.

For example, it can be determined whether the center point of the area enclosed by the bounding box corresponding to the target object is within the game area. In some implementations, it can be determined whether x₀ is between the maximum and minimum values of the abscissas of the four vertices of the game area, and whether y₀ is between the maximum and minimum values of the ordinates of the four vertices of the game area. In response to satisfying both conditions, it can be determined that the center point is in the game area; if at least one of the above two conditions is not satisfied, it can be determined that the center point is not in the game area.

For another example, an overlapping area between the bounding box and the game area can be determined according to the vertex coordinates of the bounding box, and the position of the target object is determined to be within the game area when a ratio of the overlapping area to an area of the game area exceeds a preset ratio.

In response to the position of the target object being within the game area, it can be determined that the game area involves the target object.

After the foregoing steps are performed for each of the one or more game coin objects and each of the one or more card objects appearing in the tabletop image, it can be determined whether the game area involves a game coin object and a card object.

In some implementations, it can be determined whether the game area on the game table involves a game coin object and a card object according to a hot zone mapping method. Referring to FIG. 3, FIG. 3 is a schematic diagram illustrating a process of determining a game coin placement area and a card placement area according to the present disclosure.

As shown in FIG. 3, when S1062 is performed, specifically, S302 can be performed first to obtain a tabletop hot zone map corresponding to the tabletop image, the tabletop hot zone map includes a game hot zone which corresponds to an image block in the tabletop image associated with the game area. Then S304 can be performed to, determine at least one of one or more first hot zones and one or more second hot zones in the tabletop hot zone map, according to the position information of each of the one or more target objects, wherein each of the one or more card objects is involved in one of the one or more first hot zones in the tabletop hot zone map and each of the one or more game coin objects is involved in one of the one or more second hot zones in the tabletop hot zone map. Afterwards, S306 can be performed. In response to that the one or more first hot zones cover the game hot zone, it is determined that the game area involves a card object; and in response to that the one or more first hot zones do not cover the game hot zone, it is determined that the game area involves none card object; in response to that the one or more second hot zones cover the game hot zone, it is determined that the game area involves a game coin object; and in response to that the one or more second hot zones do not cover the game hot zone, it is determined that the game area involves none game coin object.

The tabletop hot zone map is generated based on a tabletop image captured for the game tabletop. The field of view area covered by the hot zone map is the same as the field of view area covered by the tabletop image. The hot zone map can represent area division information of the game tabletop, and the area division information includes position information of each of the plurality of areas obtained by performing area division on the game tabletop. In some implementations, a tabletop image captured for a game tabletop can be obtained. Then, according to the mapping of different areas of the game tabletop in the tabletop image, the tabletop image can be divided into areas to obtain a hot zone map. Different areas in the hot zone map can be represented by different pixel values, so that areas can be distinguished readily by color, and an area to which a position of an object detected from the image belongs can be quickly mapped through the pixel value. The hot zone map can include the game hot zone which corresponds to the image block in the tabletop image associated with the game area.

In some implementations, the tabletop hot zone map can be stored in a storage medium of the node device. When S302 is performed, the node device can obtain the tabletop hot zone map from the storage medium.

Then, when S304 is performed, each of the game coin objects and each of the card objects can be used as a target object, and perform the following steps.

Determining, according to positional coordinates of a pixel (for example, the pixel in the center position) within a bounding box of the target object in the tabletop image, a target pixel having the positional coordinates in the tabletop hot zone map;

In response to the target object being a card object, determining a hot zone including the target pixel as the first hot zone; and

In response to the target object being a game coin object, determining a hot zone including the target pixel as the second hot zone.

Since different hot zones correspond to pixel values related with different target objects, after a pixel value corresponding to the pixel at the preset position in the bounding box of the target object is determined, the hot zone where the target object is involved can be determined, thereby accurately determining a first hot zone where a card object in the tabletop image is involved and a second hot zone where a game coin object in the tabletop image is involved, thus improving the accuracy of game state switching.

In some implementations, the node device can store each target object in association with corresponding hot zone.

In some implementations, different hot zones can be represented by different identifiers. By matching corresponding identifiers of two hot zones, it can be determined whether the two hot zones are the same.

In this example, the node device can store, a first identifier of each of the one or more first hot zones in association with the card object involved in the first hot zone in a second message queue; store, a second identifier of each of the one or more second hot zones in association with the game coin object involved in the second hot zone in the second message queue. Thereby, the association information between objects and hot zones is stored in a message queue, which can facilitate other units to invoke associated information and improve the efficiency of game state switching.

In some implementations, when S306 is performed, each of the card objects together with corresponding first identifier and each of the game coin objects together with corresponding second identifier can be obtained from the second message queue.

In response to that one of the obtained first identifiers matches an identifier of the game hot zone, it is determined that the one or more first hot zones cover the game hot zone.

In response to that one of the obtained second identifiers matches the identifier of the game hot zone, it is determined that the one or more second hot zones cover the game hot zone.

Thus, the identifier of the hot zone of the card object or the game coin object can be matched with the identifier of the game hot zone. If the matching result is yes, it can be determined that the card object or the game coin object is involved in the game hot zone, that is, it can be determined that the first hot zone corresponding to the card object or the second hot zone corresponding to the game coin object covers the game hot zone, which means that the game area involves a card object or a game coin object.

If the identifiers of the hot zones of each of the card objects and each of the game coin objects involved in the tabletop image do not match the identifier of the game hot zone, it can be determined that each of the card objects and each of the game coin objects are not involved in the game hot zone. That is, neither the first hot zones nor the second hot zones cover the game hot zone, which means that the game area does not involve a card object and a game coin object.

In some implementations, the node device can use different methods to determine whether the game coin storage box is in a closed state according to different types of the game coin storage box.

The game coin storage box can indicate a game coin storage box with a lid or a game coin storage box without a lid. Here, when the game coin storage box indicates a game coin storage box with a lid, the tabletop hot zone map further includes a first game coin storage box hot zone which corresponds to an image block in the tabletop image associated with the game coin storage box. When the game coin storage box is opened, the first game coin storage box hot zone contains a game coin; when the game coin storage box is closed, the first game coin storage box hot zone does not include any game coin. Therefore, it can be determined whether the game coin storage box is in the closed state by detecting whether the first game coin storage box hot zone includes a game coin.

When S1064 is performed, it can be determined whether the one or more second hot zones corresponding to the one or more game coin objects cover the first game coin storage box hot zone. In response to that the one or more second hot zones cover the first game coin storage box hot zone, it is determined that the game coin storage box is in an opened state. In response to that the one or more second hot zones do not cover the first game coin storage box hot zone, it is determined that the game coin storage box is in the closed state.

Therefore, if the one or more second hot zones cover the first game coin storage box hot zone, it can be determined that the position corresponding to the game coin storage box object contains a game coin, and it can also be determined that the game coin storage box is in the opened state. Otherwise, if the second hot zone corresponding to each game coin object in the tabletop image does not cover the first game coin storage box hot zone, it can be determined that the position corresponding to the game coin storage box object does not contain any game coin, that is, it can be determined that the game coin storage box is in the closed state. Therefore, the opened or closed state of the game coin storage box with a lid can be accurately determined.

When the game coin storage box indicates a game coin storage box without a lid, the game coin storage box includes a preset game coin storage layer. The preset game coin storage layer locates in different areas on the game table depending on that the game coin storage box is in an opened or closed state. The tabletop hot zone map further includes a second game coin storage box hot zone which corresponds to an image block in the tabletop image associated with the preset game coin storage layer when the game coin storage box is opened.

In some implementations, the preset game coin storage layer can indicate a top game coin storage layer at the topmost layer. When the game coin storage box is opened, the top game coin storage layer will be pushed out to the position where the second game coin storage box hot zone is located; when the game coin storage box is closed, the top game coin storage layer will be retracted. Therefore, it can be determined whether the game coin storage box is in the closed state by detecting whether the second game coin storage box hot zone involves a game coin object.

When S1064 is performed, it can be determined whether one or more second hot zones corresponding to the one or more game coin objects cover the second game coin storage box hot zone. In response to that the one or more second hot zones cover the second game coin storage box hot zone, it is determined that the game coin storage box is in an opened state. In response to that the one or more second hot zones do not cover the second game coin storage box hot zone, it is determined that the game coin storage box is in the closed state.

Therefore, if the one or more second hot zones cover the second game coin storage box hot zone, it can be determined that when the game coin storage box is opened, the position corresponding to the preset game coin storage layer includes a game coin, and it can be determined that the game coin storage box is in the opened state. Otherwise, if none of the one or more second hot zones corresponding to the one or more game coin objects involved in the tabletop image covers the second game coin storage box hot zone, it can be determined that when the game coin storage box is opened, the position corresponding to the preset game coin storage layer does not include any game coin, and it can be determined that the game coin storage box is in the closed state. Therefore, the opened or closed state of the game coin storage box without a lid can be accurately determined.

After determining whether the game area involves a card object and a game coin object, and determining whether the game coin storage box on the game table is in the closed state, S108 can be performed.

In some implementations, the node device can obtain a game state identifier that represents a current game stage of the game; in response to that the game state identifier matches an identifier of the game coin settlement state, it is determined that the game currently is in the game coin settlement state.

Then the node device obtains the determining result of whether the game area involves a card object and a game coin object, and whether the game coin storage box on the game table is in the closed state. In response to no card objects and game coin objects being in the game area, and the game coin storage box being in the closed state, the game is switched to the game starting state. In this way, the game state can be automatically switched according to the tabletop image corresponding to the tabletop game.

The following implementations are described in conjunction with a scene of card game state switching.

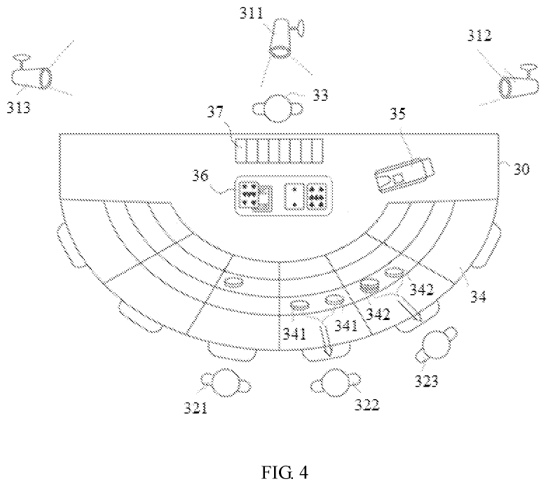

Referring to FIG. 4, FIG. 4 is a schematic diagram illustrating a game scene according to the present disclosure.

The game scene as shown in FIG. 4 can include a game table 30 used for a card game, cameras 311-313 disposed respectively right above the game table 30, at the upper left, and the upper right of the game table 30, players 321-323 around the game table, and a game manager 33.

Here, the tabletop 30 includes a game coin placement area 34 for placing game coins, a placement area of a card dealing device 35, a card placement area 36 for placing cards, and a game coin storage box area 37. The game coin placement area 34 is provided with game coins 341-342.

In this example, a game coin storage box placed in the game coin storage box area 37 indicates a double-layer slide-in type game coin storage box without a lid.

In a card game, at least a game coin placement stage, a card dealing stage, and a game coin settlement stage can be included. In the game coin settlement stage, the game manager will determine the winner and the loser based on the point of poker cards held by a first participant and a second participant in the card placement area 36, and based on the situation of game coins placed by the winner and the loser, payment is made with the game coins in the game coin storage box. When the settlement is completed, the game coin placement area 34 and the card placement area 36 should not include any playing card and game coin and the game coin storage box should be in a closed state.

In the scene, the camera 31 can be connected to a node device. The node device can correspond to the tabletop as an edge computing device. The node device can maintain the identifier of the game state corresponding to the current game stage, so as to monitor the game process according to the game rules corresponding to the current game state.

In this example, the tabletop hot zone map corresponding to the tabletop 30 can be maintained in the node device. The hot zone map includes a card placement hot zone corresponding to the card placement area 36, a game coin placement hot zone corresponding to the game coin placement area 34, and when the game coin storage box is opened, the second game coin storage box hot zone corresponding to the area where the top game coin storage layer is located.

The camera 31 can capture a tabletop image corresponding to the tabletop 30 in real time, and transmit the tabletop image to the node device.

The node device can obtain the tabletop image, and use the object detection model to perform object detection on the tabletop image. Whenever a bounding box of any type of object is detected, coordinates corresponding to the center point of the area enclosed by the bounding box is stored in association with the object to the first message queue. To facilitate the description of the implementations below, in some steps, the types of objects are not distinguished, and the objects are collectively referred to as target objects. It is understandable that the target objects can refer to either card objects or game coin objects.

The node device can monitor the first message queue, and obtain coordinate information corresponding to the center point of the area enclosed by the bounding box of the target object stored in the first message queue. Afterwards, according to the coordinate information corresponding to the center point, a target pixel in the tabletop hot zone map at the same position as the center point is determined, and a hot zone corresponding to the target object is determined according to a pixel value corresponding to the target pixel.

The node device can store an identifier of the hot zone corresponding to the target object in association with the target object in the second message queue.

The node device can monitor the second message queue, and obtain the identifier of the hot zone corresponding to the target object stored in the second message queue. Afterwards, according to the identifier, the identifier corresponding to the hot zone for the card placement area, the identifier corresponding to the hot zone for the game coin placement area, and the identifier corresponding to the second game coin storage box hot zone, it can be determined that the hot zone corresponding to the target object is which one of the hot zone for the card replacement area, the hot zone for the game coin placement area, or the second game coin storage box hot zone.

After the hot zone determination is completed for each of the card objects and each of the game coin objects involved in the tabletop image, the node device can determine, for each of the card objects, whether a first hot zone corresponding to the card object covers the hot zone for the card placement area. If so, it is determined that the card placement area 36 includes a card. Otherwise, it is determined that the card placement area 36 does not include any card.

The node device can further determine, for each of the game coin objects, whether a second hot zone corresponding to the game coin object covers the hot zone for the game coin placement. If so, it can be determined that the game coin placement area 34 includes a game coin. Otherwise, it can be determined that the game coin placement area 34 does not include any game coin.

The node device can further determine, for each of the game coin objects, whether a second hot zone corresponding to the game coin object covers the second game coin storage box hot zone. If it is, it can be determined that the game coin storage box is in an opened state. Otherwise, it can be determined that the game coin storage box is in a closed state.

In response to the card placement area 36 does not include any card, the game coin placement area 34 does not include any game coin, and the game coin storage box is in the closed state, the node device can further obtain an identifier of the currently maintained game state and determine whether the identifier represents the game coin settlement state. If so, the node device can update the identifier of the game state to an identifier corresponding to the game coin placement state. Therefore the switching of the game state can be automatically completed, on the one hand, it is friendly to the game manager and enhances the game experience of the player; on the other hand, it can avoid abnormal game state switching caused by the game manager accidentally touching the button or forgetting to trigger the button.

Corresponding to any of the above implementations, the present disclosure also proposes an apparatus 50 for switching states of a tabletop game.

Referring to FIG. 5, FIG. 5 is a schematic block diagram of an apparatus for switching states of a tabletop game according to the present disclosure. As shown in FIG. 5, the apparatus 50 can include: an obtaining module 51 configured to obtain a tabletop image of a tabletop game which is in a game coin settlement state; an object detecting module 52 configured to obtain position information of each of one or more target objects involved in the tabletop image by performing object detection on the tabletop image, wherein the one or more target objects include at least one of one or more card objects and one or more game coin objects; a determining module 53 configured to determine, according to the position information of each of the one or more target objects, whether a game area of a game table involves a target object, and whether a game coin storage box on the game table is in a closed state; and a switching module 54 configured to switch the game to a game starting state, in response to determining that the game area involves none target object and the game coin storage box is in the closed state.

In some implementations, the determining module 53 is configured to: obtain a tabletop hot zone map corresponding to the tabletop image; wherein the tabletop hot zone map includes a game hot zone which corresponds to an image block in the tabletop image associated with the game area; determine, according to the position information of each of the one or more target objects, at least one of one or more first hot zones and one or more second hot zones in the tabletop hot zone map, wherein each of the one or more card objects is involved in one of the one or more first hot zones in the tabletop hot zone map and each of the one or more game coin objects is involved in one of the one or more second hot zones in the tabletop hot zone map; in response to that the one or more first hot zones cover the game hot zone, determine that the game area involves a card object; in response to that the one or more first hot zones do not cover the game hot zone, determine that the game area involves none card object; in response to that the one or more second hot zones cover the game hot zone, determine that the game area involves a game coin object; and in response to that the one or more second hot zones do not cover the game hot zone, determine that the game area involves none game coin object.

In some implementations, the apparatus 50 further includes: a storage module configured to store the obtained position information of each of the one or more target objects in a first message queue; store, in a second message queue in a case where the one or more target objects include the one or more card objects, a first identifier of each of the one or more first hot zones in association with the card object involved in the first hot zone; and store, in the second message queue in a case where the one or more target objects include the one or more game coin objects, a second identifier of each of the one or more second hot zones in association with the game coin object involved in the second hot zone.

In some implementations, the apparatus 50 further includes: a hot zone determining module configured to obtain, from the second message queue, each of the card objects together with corresponding first identifier and each of the game coin objects together with corresponding second identifier; in response to that one of the obtained first identifiers matches an identifier of the game hot zone, determine that the one or more first hot zones cover the game hot zone; and in response to that one of the obtained second identifiers matches the identifier of the game hot zone, determine that the one or more second hot zones cover the game hot zone.

In some implementations, the determining module 53 is configured to: determine, according to positional coordinates of a pixel within a bounding box of the target object in the tabletop image, a target pixel having the positional coordinates in the tabletop hot zone map; determine, in response to the target object being a card object, a hot zone including the target pixel as the first hot zone; and determine, in response to the target object being a game coin object, a hot zone including the target pixel as the second hot zone.

In some implementations, the tabletop hot zone map further includes a first game coin storage box hot zone which corresponds to an image block in the tabletop image associated with the game coin storage box; the determining module 53 is configured to: in response to that the one or more second hot zones cover the first game coin storage box hot zone, determine that the game coin storage box is in an opened state; and in response to that the one or more second hot zones do not cover the first game coin storage box hot zone, determine that the game coin storage box is in the closed state.

In some implementations, the game coin storage box includes a preset game coin storage layer; the tabletop hot zone map further includes a second game coin storage box hot zone which corresponds to an image block in the tabletop image associated with the preset game coin storage layer when the game coin storage box is opened; the determining module 53 is configured to: in response to that the one or more second hot zones cover the second game coin storage box hot zone, determine that the game coin storage box is in an opened state; and in response to that the one or more second hot zones do not cover the second game coin storage box hot zone, determine that the game coin storage box is in the closed state.

In some implementations, the apparatus 50 further includes: a game state determining module configured to obtain a game state identifier that represents a current game stage of the game; and in response to that the game state identifier matches an identifier of the game coin settlement state, determine that the game currently is in the game coin settlement state.

In some implementations, the game area includes a card placement area and a game coin placement area; and the game starting state includes a game coin placement state.

The implementation of the apparatus for switching states of a tabletop game according to the present disclosure can be applied to an electronic device. Correspondingly, the present application discloses an electronic device, which can include a processor; a memory used to store processor-executable instructions. Wherein, the processor is configured to invoke the executable instructions stored in the memory to implement the method for switching states of the tabletop game shown in any of the above implementations.

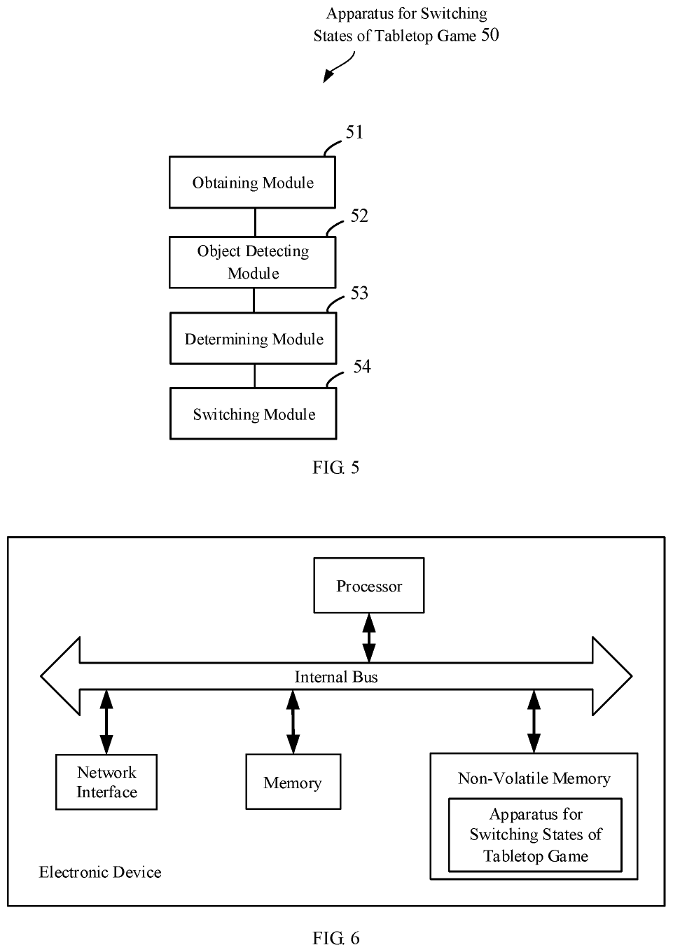

Referring to FIG. 6, FIG. 6 is a schematic diagram illustrating a hardware structure of an electronic device according to the present disclosure.

As shown in FIG. 6, the electronic device can include a processor for executing instructions, a network interface for network connection, a memory for storing operating data for the processor, and a non-volatile memory for storing instructions corresponding to the apparatus for switching states.

The embodiments of the apparatus can be implemented by software, or can be implemented by hardware or a combination of software and hardware. Taking software implementation as an example, as a logical apparatus, it is formed by reading the corresponding computer program instructions in the non-volatile memory into the memory through the processor of the electronic device where it is located. From a hardware perspective, in addition to the processor, memory, network interface, and non-volatile memory shown in FIG. 6, the electronic device in which the apparatus is located in the implementation usually includes other hardware based on the actual function of the electronic device, which is not elaborated herein.

It can be understood that, in order to increase the processing speed, the corresponding instruction of the apparatus for switching a state can also be directly stored in the memory, which is not limited here.

The present application proposes a computer-readable storage medium that stores a computer program, and the computer program can be used to cause a processor to perform the method of switching states of a tabletop game as shown in any of the above implementations.

Those skilled in the art should understand that one or more implementations of the present application can be provided as a method, a system, or a computer program product. Therefore, one or more implementations of the present application can adopt the form of a pure hardware implementation, a pure software implementation, or an implementation combining software and hardware. Moreover, one or more implementations of the present application can be in a form of a computer program product implemented on one or more computer-usable storage media (which can include but not limited to disk storage, CD-ROM, optical storage, etc.) containing computer-usable program codes.

In the present disclosure, “and/or” means having at least one of the two. For example, “A and/or B” can include three schemes: A, B, and “A and B”.

The various implementations in the present disclosure are described in a progressive manner, and the same or similar parts between the various implementations can be referred to each other, and each implementation focuses on the differences from other implementations. In particular, for the data processing device implementation, since it is basically similar to the method implementation, the description is relatively simple, and for related parts, reference can be made to the part of the description of the method implementation.

The specific implementations of the present application have been described above. Other implementations are within the scope of the appended claims. In some cases, the actions or steps described in the claims can be performed in a different order than in the implementations and can still achieve desired results. In addition, the processes depicted in the drawings do not necessarily require the specific order or sequential order shown to achieve the desired results. In some implementations, multitasking and parallel processing are also possible or can be advantageous.

The implementations of the subject and functional operations described in the present disclosure can be implemented in the following: digital electronic circuits, tangible computer software or firmware, computer hardware that can include the structures disclosed in the present disclosure and their structural equivalents, or a combination of one or more of them. The implementations of the subject matter described in the present disclosure can be implemented as one or more computer programs, that is, one or one of the computer program instructions encoded on a tangible non-transitory program carrier to be executed by a data processing apparatus or one or more modules in the computer program instructions for controlling the operation of the data processing apparatus. Alternatively or additionally, the program instructions can be encoded on artificially generated propagated signals, such as machine-generated electrical, optical, or electromagnetic signals, which are generated to encode information and transmit it to a suitable receiver apparatus to be executed by a processing apparatus. The computer storage medium can be a machine-readable storage apparatus, a machine-readable storage substrate, a random or serial access memory device, or a combination of one or more of them.

The processing and logic flow described in the present disclosure can be executed by one or more programmable computers executing one or more computer programs to perform corresponding functions by operating according to input data and generating output. The processing and logic flow can also be executed by a dedicated logic circuit, such as FPGA (Field Programmable Gate Array) or ASIC (Application Specific Integrated Circuit), and the apparatus can also be implemented as a dedicated logic circuit.

A computer suitable for executing a computer program can include, for example, a general-purpose and/or special-purpose microprocessor, or any other type of central processing unit. Generally, the central processing unit will receive instructions and data from a read-only memory and/or a random access memory. The basic components of a computer can include a central processing unit that can be used to implement or execute instructions and one or more memory devices that can be used to store instructions and data. Generally, the computer will also include one or more mass storage devices that can be used to store data, such as magnetic disks, magneto-optical disks, or optical disks, or the computer will be operatively coupled to this mass storage device to receive data from it or send data to it, or both. However, the computer does not have to have such equipment. In addition, the computer can be embedded in another device, such as a mobile phone, a personal digital assistant (PDA), a mobile audio or video player, a game console, a global positioning system (GPS) receiver, or, for example, a universal serial bus (USB) Flash drives are portable storage devices, to name a few.

Computer-readable media suitable for storing computer program instructions and data can include all forms of non-volatile memory, media, and memory devices, such as semiconductor memory devices (such as EPROM, EEPROM, and flash memory devices), and magnetic disks (such as internal hard disks). Or removable disks), magneto-optical disks, and CD ROM and DVD-ROM disks. The processor and the memory can be supplemented by or incorporated into a dedicated logic circuit.

Although the present disclosure contains many specific implementation details, these should not be construed as limiting any disclosed scope or claimed scope, but can be mainly used to describe the features of specific disclosed specific implementations. Certain features described in multiple implementations in the present disclosure can also be implemented in combination in a single implementation. On the other hand, various features described in a single implementation can also be implemented in multiple implementations separately or in any suitable sub-combination. In addition, although features can function in certain combinations as described and even initially claimed as such, one or more features from the claimed combination can in some cases be removed from the combination, and the combination of claimed protection can be directed to a sub-combination or a variant of the sub-combination.

Similarly, although operations are depicted in a specific order in the drawings, this should not be construed as requiring these operations to be performed in the specific order shown or sequentially, or requiring all illustrated operations to be performed to achieve the desired result. In some cases, multitasking and parallel processing can be advantageous. In addition, the separation of various system modules and components in the described implementations should not be understood as requiring such separation in all implementations, and it should be understood that the described program components and systems can generally be integrated together in a single software In the product, or packaged into multiple software products.

Thus, specific implementations of the subject matter have been described. Other implementations are within the scope of the appended claims. In some cases, the actions recited in the claims can be performed in a different order and still achieve desired results. In addition, the processes depicted in the drawings are not necessarily in the specific order or sequential order shown in order to achieve the desired result. In some implementations, multitasking and parallel processing can be advantageous.

The above are only preferred implementations of one or more implementations of the present application, and are not used to limit one or more implementations of the present application. Any modification, equivalent replacement, improvement, etc. of within the spirit and principle of one or more implementations of the present application should be included in the protection scope of one or more implementations of the present disclosure.

1. A method of switching states of a tabletop game, comprising:
obtaining a tabletop image of a tabletop game which is in a game coin settlement state;
obtaining position information of each of one or more target objects involved in the tabletop image by performing object detection on the tabletop image, wherein the one or more target objects comprise at least one of one or more card objects and one or more game coin objects;
determining, according to the position information of each of the one or more target objects, whether a game area of a game table involves a target object;
determining whether a game coin storage box on the game table is in a closed state; and
switching, in response to determining that the game area involves none target object and the game coin storage box is in the closed state, the game to a game starting state.

2. The method of claim 1, wherein determining, according to the position information of each of the one or more objects, whether the game area of the game table involves a target object, comprises:
obtaining a tabletop hot zone map corresponding to the tabletop image, wherein the tabletop hot zone map comprises a game hot zone which corresponds to an image block in the tabletop image associated with the game area;
determining, according to the position information of each of the one or more target objects, at least one of one or more first hot zones and one or more second hot zones in the tabletop hot zone map, wherein each of the one or more card objects is involved in one of the one or more first hot zones in the tabletop hot zone map and each of the one or more game coin objects is involved in one of the one or more second hot zones in the tabletop hot zone map;
determining, in response to that the one or more first hot zones cover the game hot zone, that the game area involves a card object;
determining, in response to that the one or more first hot zones do not cover the game hot zone, that the game area involves none card object;
determining, in response to that the one or more second hot zones cover the game hot zone, that the game area involves a game coin object; and
determining, in response to that the one or more second hot zones do not cover the game hot zone, that the game area involves none game coin object.

3. The method of claim 2, further comprising:
storing the obtained position information of each of the one or more target objects in a first message queue;
storing, in a second message queue in a case where the one or more target objects comprise the one or more card objects, a first identifier of each of the one or more first hot zones in association with the card object involved in the first hot zone; and
storing, in the second message queue in a case where the one or more target objects comprise the one or more game coin objects, a second identifier of each of the one or more second hot zones in association with the game coin object involved in the second hot zone.

4. The method of claim 3, further comprising:
obtaining, from the second message queue, each of the card objects together with corresponding first identifier and each of the game coin objects together with corresponding second identifier;
determining, in response to that one of the obtained first identifiers matches an identifier of the game hot zone, that the one or more first hot zones cover the game hot zone; and
determining, in response to that one of the obtained second identifiers matches the identifier of the game hot zone, that the one or more second hot zones cover the game hot zone.

5. The method of claim 2, wherein determining, according to the position information of each of the one or more target objects, at least one of the one or more first hot zones and the one or more second hot zones in the tabletop hot zone map, comprises:
determining, according to positional coordinates of a pixel within a bounding box of the target object in the tabletop image, a target pixel having the positional coordinates in the tabletop hot zone map;
determining, in response to the target object being a card object, a hot zone comprising the target pixel as the first hot zone; and
determining, in response to the target object being a game coin object, a hot zone comprising the target pixel as the second hot zone.

6. The method of claim 2, wherein
the tabletop hot zone map further comprises a first game coin storage box hot zone which corresponds to an image block in the tabletop image associated with the game coin storage box;
determining whether the game coin storage box on the game table is in the closed state comprises:
determining, in response to that the one or more second hot zones cover the first game coin storage box hot zone, that the game coin storage box is in an opened state; and
determining, in response to that the one or more second hot zones do not cover the first game coin storage box hot zone, that the game coin storage box is in the closed state.

7. The method of claim 2, wherein
the game coin storage box comprises a preset game coin storage layer;
the tabletop hot zone map further comprises a second game coin storage box hot zone which corresponds to an image block in the tabletop image associated with the preset game coin storage layer when the game coin storage box is opened;
determining whether the game coin storage box on the game table is in the closed state comprises:
determining, in response to that the one or more second hot zones cover the second game coin storage box hot zone, that the game coin storage box is in an opened state; and
determining, in response to that the one or more second hot zones do not cover the second game coin storage box hot zone, that the game coin storage box is in the closed state.

8. The method of claim 1, further comprising:
obtaining a game state identifier that represents a current game stage of the game; and
determining, in response to that the game state identifier matches an identifier of the game coin settlement state, that the game currently is in the game coin settlement state.

9. The method of claim 1, wherein
the game area comprises a card placement area and a game coin placement area; and
the game starting state comprises a game coin placement state.

10. An electronic device comprising:
at least one processor; and
one or more memories coupled to the at least one processor and storing programming instructions for execution by the at least one processor to perform operations for switching states of a tabletop game, the operations comprising:
obtaining a tabletop image of a tabletop game which is in a game coin settlement state;
obtaining position information of each of one or more target objects involved in the tabletop image by performing object detection on the tabletop image, wherein the one or more target objects comprise at least one of one or more card objects and one or more game coin objects;
determining, according to the position information of each of the one or more target objects, whether a game area of a game table involves a target object;
determining whether a game coin storage box on the game table is in a closed state; and
switching, in response to determining that the game area involves none target object and the game coin storage box is in the closed state, the game to a game starting state.

11. The electronic device of claim 10 wherein determining, according to the position information of each of the one or more objects, whether the game area of the game table involves a target object, comprises:
obtaining a tabletop hot zone map corresponding to the tabletop image, wherein the tabletop hot zone map comprises a game hot zone which corresponds to an image block in the tabletop image associated with the game area;
determining, according to the position information of each of the one or more target objects, at least one of one or more first hot zones and one or more second hot zones in the tabletop hot zone map, wherein each of the one or more card objects is involved in one of the one or more first hot zones in the tabletop hot zone map and each of the one or more game coin objects is involved in one of the one or more second hot zones in the tabletop hot zone map;
determining, in response to that the one or more first hot zones cover the game hot zone, that the game area involves a card object;
determining, in response to that the one or more first hot zones do not cover the game hot zone, that the game area involves none card object;
determining, in response to that the one or more second hot zones cover the game hot zone, that the game area involves a game coin object; and
determining, in response to that the one or more second hot zones do not cover the game hot zone, that the game area involves none game coin object.

12. The electronic device of claim 11, the operations further comprising:
storing the obtained position information of each of the one or more target objects in a first message queue;
storing, in a second message queue in a case where the one or more target objects comprise the one or more card objects, a first identifier of each of the one or more first hot zones in association with the card object involved in the first hot zone; and
storing, in the second message queue in a case where the one or more target objects comprise the one or more game coin objects, a second identifier of each of the one or more second hot zones in association with the game coin object involved in the second hot zone.

13. The electronic device of claim 12, the operations further comprising:
obtaining, from the second message queue, each of the card objects together with corresponding first identifier and each of the game coin objects together with corresponding second identifier;
determining, in response to that one of the obtained first identifiers matches an identifier of the game hot zone, that the one or more first hot zones cover the game hot zone; and
determining, in response to that one of the obtained second identifiers matches the identifier of the game hot zone, that the one or more second hot zones cover the game hot zone.

14. The electronic device of claim 11, wherein determining, according to the position information of each of the one or more target objects, at least one of the one or more first hot zones and the one or more second hot zones in the tabletop hot zone map, comprises:
determining, according to positional coordinates of a pixel within a bounding box of the target object in the tabletop image, a target pixel having the positional coordinates in the tabletop hot zone map;
determining, in response to the target object being a card object, a hot zone comprising the target pixel as the first hot zone; and
determining, in response to the target object being a game coin object, a hot zone comprising the target pixel as the second hot zone.

15. The electronic device of claim 11, wherein
the tabletop hot zone map further comprises a first game coin storage box hot zone which corresponds to an image block in the tabletop image associated with the game coin storage box;
determining whether the game coin storage box on the game table is in the closed state comprises:
determining, in response to that the one or more second hot zones cover the first game coin storage box hot zone, that the game coin storage box is in an opened state; and
determining, in response to that the one or more second hot zones do not cover the first game coin storage box hot zone, that the game coin storage box is in the closed state.

16. The electronic device of claim 11, wherein
the game coin storage box comprises a preset game coin storage layer;
the tabletop hot zone map further comprises a second game coin storage box hot zone which corresponds to an image block in the tabletop image associated with the preset game coin storage layer when the game coin storage box is opened;
determining whether the game coin storage box on the game table is in the closed state comprises:
determining, in response to that the one or more second hot zones cover the second game coin storage box hot zone, that the game coin storage box is in an opened state; and
determining, in response to that the one or more second hot zones do not cover the second game coin storage box hot zone, that the game coin storage box is in the closed state.

17. The electronic device of claim 10, the operations further comprising:
obtaining a game state identifier that represents a current game stage of the game; and
determining, in response to that the game state identifier matches an identifier of the game coin settlement state, that the game currently is in the game coin settlement state.

18. The electronic device of claim 10, wherein
the game area comprises a card placement area and a game coin placement area; and
the game starting state comprises a game coin placement state.

19. A non-transitory computer-readable storage medium coupled to the at least one processor and storing programming instructions for execution by the at least one processor, wherein the programming instructions instruct the at least one processor to perform operations for switching states of a tabletop game, the operations comprising:
obtaining a tabletop image of a tabletop game which is in a game coin settlement state;
obtaining position information of each of one or more target objects involved in the tabletop image by performing object detection on the tabletop image, wherein the one or more target objects comprise at least one of one or more card objects and one or more game coin objects;
determining, according to the position information of each of the one or more target objects, whether a game area of a game table involves a target object;
determining whether a game coin storage box on the game table is in a closed state; and
switching, in response to determining that the game area involves none target object and the game coin storage box is in the closed state, the game to a game starting state.
